(19) United States
(12) Patent Application Publication
(10) Pub. No.: US 2024/0219015 A1
(43) Pub. Date: Jul. 4, 2024

(54) ILLUMINATION SYSTEM FOR AN INTERIOR CABIN

(71) Applicant: Gentex Corporation, Zeeland, MI (US)

(72) Inventors: Christopher B. Case, Byron Center, MI (US); Brock R. Rycenga, Wyoming, MI (US); Eric S. Lundy, Holland, MI (US); Guy Raz, Binyamina (IL)

(73) Assignee: Gentex Corporation, Zeeland, MI (US)

(21) Appl. No.: 18/402,930

(22) Filed: Jan. 3, 2024

Related U.S. Application Data
(60) Provisional application No. 63/478,236, filed on Jan. 3, 2023.

(51) Int. Cl. F21V 23/04; F21V 14/06; G06V 40/20; H04N 23/11; H04N 23/56

(52) U.S. Cl. CPC F21V 23/0478; F21V 14/06; G06V 40/28; H04N 23/11; H04N 23/56; F21Y 2115/10

(57) ABSTRACT

An illumination system includes at least one first light-emitting diode that is configured to project a first light within a cool visible spectrum and at least one second light-emitting diode that is configured to project a second light within a warm visible spectrum. An imaging assembly includes an infrared light source that is configured to project an infrared light and an imager that captures an image of a reflection of the infrared light from a surface of an object. A processor is configured to extract a 2-dimensional (“2D”) representation of the object from the image, identify and categorize the object, and generate an illumination signal to at least one of the at least one first light-emitting diode or the at least one second light-emitting diode based on the category of the object to illuminate the object.

### CROSS-REFERENCE TO RELATED APPLICATION

This application claims priority to and the benefit under 35 U.S.C. § 119(e) of U.S. Provisional Application No. 63/478,236, filed on Jan. 3, 2023, entitled “ILLUMINATION SYSTEM FOR AN INTERIOR CABIN,” the disclosure of which is hereby incorporated herein by reference in its entirety.

### FIELD OF THE DISCLOSURE

The present disclosure generally relates to an illumination system, and, more particularly, to an illumination system that switches between projected light in a cool visible spectrum and a warm visible spectrum.

### SUMMARY OF THE DISCLOSURE

According to one aspect of the present disclosure, an illumination system includes at least one first light-emitting diode that is configured to project a first light within a cool visible spectrum and at least one second light-emitting diode that is configured to project a second light within a warm visible spectrum. An imaging assembly includes an infrared light source that is configured to project an infrared light and an imager that captures an image of a reflection of the infrared light from a surface of an object. A processor is configured to extract a 2-dimensional (“2D”) representation of the object from the image, identify and categorize the object, and generate an illumination signal to at least one of the at least one first light-emitting diode or the at least one second light-emitting diode based on the category of the object to illuminate the object.

According to another aspect of the present disclosure, an illumination system includes at least one first light-emitting diode that is configured to project a first light within a first visible spectrum and at least one second light-emitting diode that is configured to project a second light within a second visible spectrum that is different than the first visible spectrum. An imaging assembly includes an infrared light source that is configured to project an infrared light and an imager that captures an image of a reflection of the infrared light from a surface of an object. A processor is configured to extract a 2-dimensional (“2D”) representation of the object from the image, identify and categorize the object, and generate an illumination signal to at least one of the at least one first light-emitting diode or the at least one second light-emitting diode based on the category of the object to illuminate the object.

According to yet another aspect of the present disclosure, an illumination system includes at least one first light-emitting diode that is configured to project a first light within a first visible spectrum and at least one second light-emitting diode that is configured to project a second light within a second visible spectrum that is different than the first visible spectrum. An imaging assembly includes an infrared light source that is configured to project an infrared light and an imager that captures an image of a reflection of the infrared light from a surface of an object. A processor is configured to extract a 2-dimensional (“2D”) representation of the object from the image, identify and categorize the object, identify a perimeter of the object, and generate an illumination signal to at least one of the at least one first light-emitting diode or the at least one second light-emitting diode based on the category of the object to illuminate at least the perimeter of the object.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an interior view of a cabin with an illumination system in accordance with the present disclosure;

FIG. 2A is a top view of an aircraft incorporating an illumination system in accordance with the present disclosure;

FIG. 2B is an elevational view of a water vessel incorporating an illumination system in accordance with the present disclosure;

FIG. 2C is an elevational view of a rail vehicle incorporating an illumination system in accordance with the present disclosure;

FIG. 3 is a schematic view of a lighting system in accordance with the present disclosure;

FIG. 4A is a top view of a table in a cabin that includes a first object in accordance with the present disclosure;

FIG. 4B is a top view of a table in a cabin that includes a second object in accordance with the present disclosure;

FIG. 4C is a top view of a table in a cabin that includes a third object in accordance with the present disclosure;

FIG. 5A is a top view of a table in a cabin with an illumination system with a first hand gesture control in accordance with the present disclosure;

FIG. 5B is a top view of a table in a cabin with an illumination system with a second hand gesture control in accordance with the present disclosure;

FIG. 6A is a perspective view of a first operational mode of an illumination system that illuminates an object in accordance with the present disclosure;

FIG. 6B is a perspective view of a second operational mode of an illumination system that illuminates a first object and a second object in a spaced apart relationship in accordance with the present disclosure;

FIG. 6C is a perspective view of a fourth operational mode of an illumination system that illuminates an object to mitigate an obstruction in accordance with the present disclosure;

FIG. 7 is a side view of an illumination system that includes a lens adjustment mechanism and a carrier adjustment mechanism in accordance with the present disclosure; and

FIG. 8 is a schematic view of a control system for an illumination system in accordance with the present disclosure.

### DETAILED DESCRIPTION

The present illustrated embodiments reside primarily in combinations of method steps and apparatus components related to an illumination system that switches between projected light in a cool visible spectrum and a warm visible spectrum. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

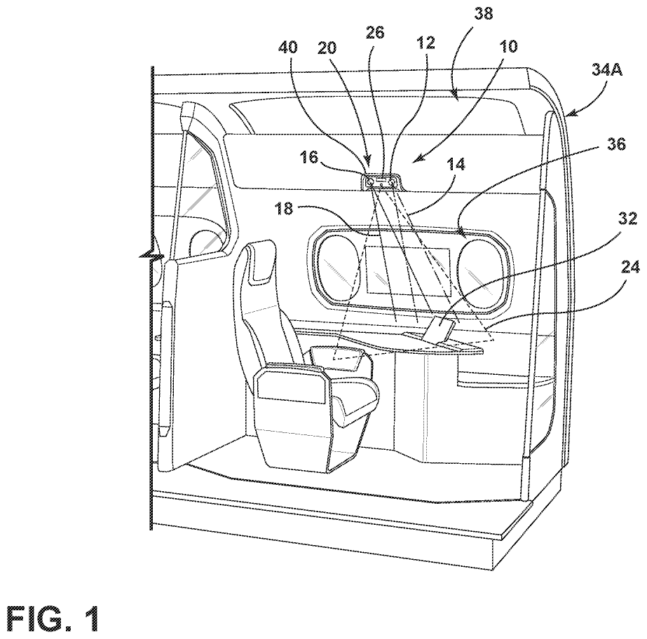

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

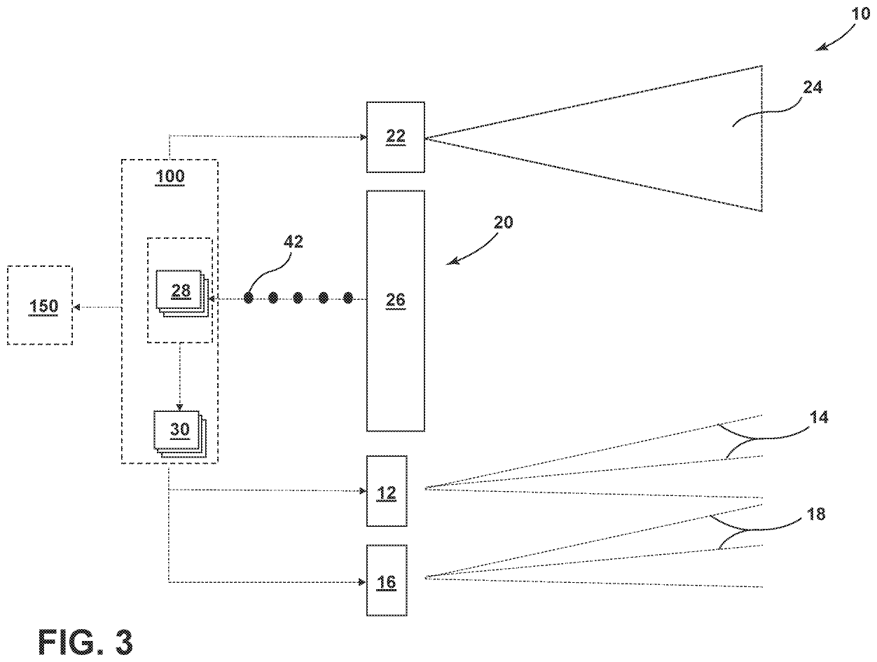

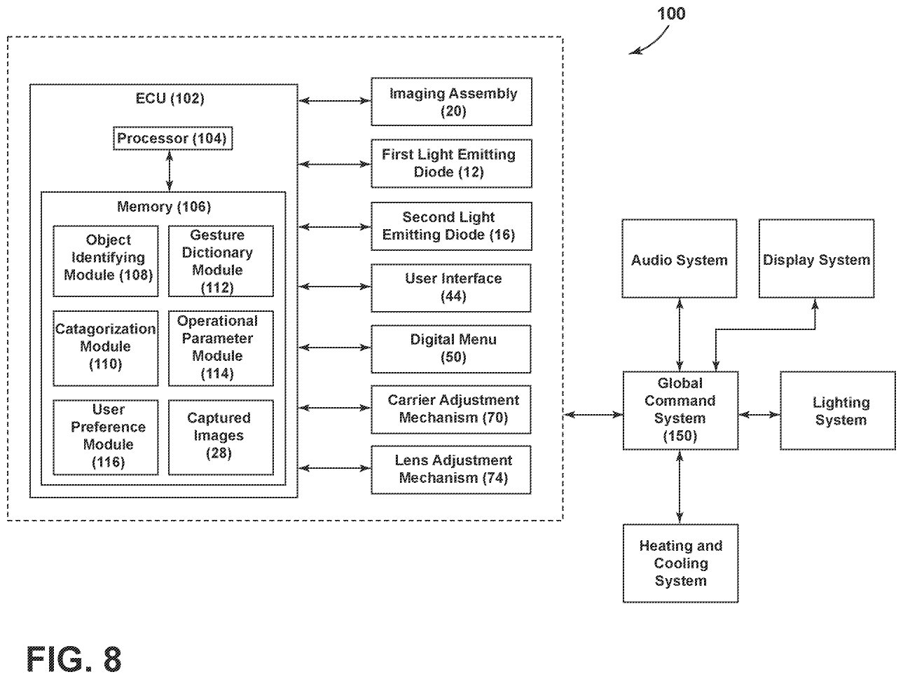

Referring to FIGS. 1-4C, reference numeral 10 generally designates an illumination system 10. The illumination system 10 includes at least one first light-emitting diode 12 that is configured to project a first light 14 within a cool visible spectrum and at least one second light-emitting diode 16 that is configured to project a second light 18 within a warm visible spectrum (FIG. 3). An imaging assembly 20 may include an infrared light source 22 (e.g., an infrared flood illumination or structured pattern) or a light in other spectrums that is configured to project light, such as an infrared light 24 and an imager 26 (e.g., a camera) that captures an image 28 of a reflection of the infrared light from a surface 30 of an object 32. A control system 100 (FIG. 8), for example, a processor 104, is configured to extract a 2-dimensional (“2D”) representation of the object 32 from the image 28, identify and categorize the object 32, and generate a signal to at least one of the at least one first light-emitting diode 12 or the at least one second light-emitting diode 16 based on the category of the object 32 (e.g., a signal to the first light-emitting diode 12 only, the second light-emitting diode 16 only, or a blend of both the first and second light-emitting diodes 12, 14).

With continued reference to FIGS. 1-4C, the cool visible spectrum may include a first visible wavelength below about 500 nm (e.g., between about 350 nm and about 500 nm) and the warm visible spectrum may include a second visible wavelength above about 500 nm (e.g., between about 500 nm and about 700 nm). In this manner, both the physical comfort and health of a user's eyes can be maximized. For example, warm light may be utilized when the object 32 is consumable (e.g., food and drink) and cool light may be utilized when the object 32 is a readable medium (e.g., a book or readable electronic device) for an enhanced user experience. However, it will be appreciated that the parameters of the type of light projected can be based on user preferences. In addition, the intensity, direction, and focus angle of the light projected can be modified to improve both physical comfort and the health of the user's eyes.

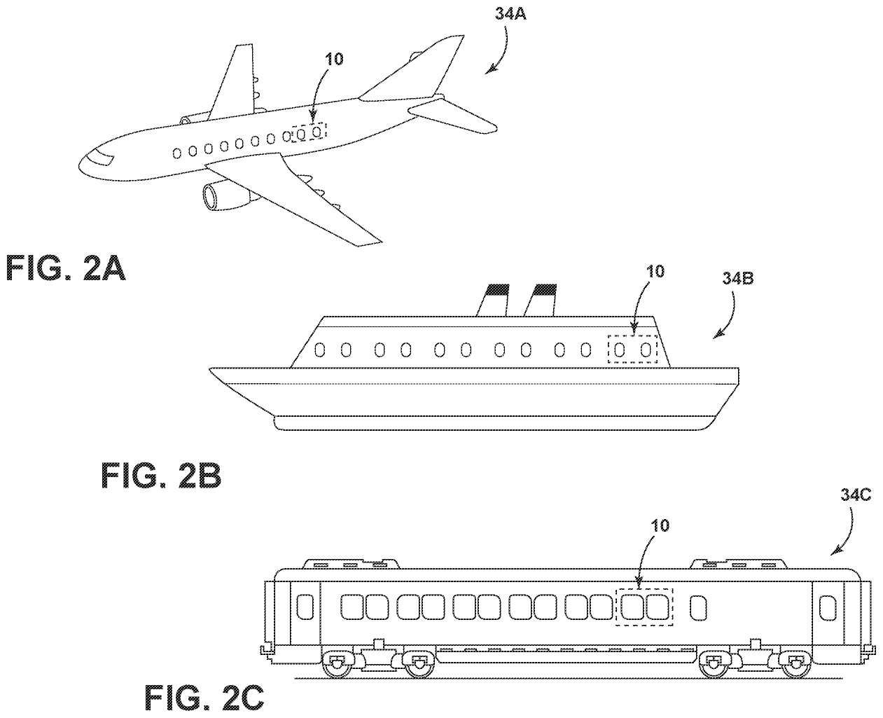

Referring now to FIGS. 2A-2C, the illumination system 10 may be incorporated with one or more structures 34A-34C. For example, FIG. 2A illustrates an aircraft 34A employing the illumination system 10. FIG. 2C illustrates a water vessel 34B employing illumination system 10. The water vessel 34B may be a cruise ship, a ship utilized for public transport, a ship utilized for commercial utility (e.g., fishing), and/or the like. FIG. 2C illustrates a rail vehicle 34C employing illumination system 10. For example, the rail vehicle 34C may be a subway train, a bullet train, a trolley, and/or the like. Generally speaking, the illumination system 10 may be incorporated into any environment where it is beneficial to change the illumination state between the warm visible spectrum and the cool visible spectrum.

With reference now to FIGS. 1-3, the illumination system 10 may be incorporated within an interior cabin 36 of the one or more structures 34A-34C. For example, FIG. 1 illustrates the illumination system 10 incorporated within the interior cabin 36 of the aircraft 34A. The at least one first light-emitting diode 12 and the at least one second light-emitting diode 16 may be located in an overhead area 38 of the cabin 36. Likewise, the imaging assembly 20 may be located in the overhead area 38 of the cabin 36. In some embodiments, the at least one first light-emitting diode 12, the at least one second light-emitting diode 16, and the imaging assembly 20 may be located within a single housing 40 (FIG. 1).

With reference now to FIG. 3, the imaging assembly 20 (e.g., the imager 26) may be configured to capture a plurality of images 28 in a time sequence of periods 42. For example, the periods 42 may be continuous (e.g., live stream) or a plurality of periods 42 between about every microsecond or second. The captured images 28 are communicated to the control system 100 where the control system 100 is configured to extract the 2D representation of the object 32, identify, and categorize the object 32. Extracting the 2D representation may include determining the presence of the object 32 and localizing the object 32 (e.g., an outer perimeter 46 of the object 32, a center of mass of the object 32, and/or the like). The control system 100 may include a user interface 44 for modifying the parameters of the type of light projected based on user preferences. The control system 100 may be in communication with a global command system 150 that corresponds to the structures 34A-34C. For example, the global command system 150 may include heating and cooling settings, display settings (e.g., a display integrated into a public transport), audio settings (e.g., speakers integrated or otherwise connected to a public transport), other lighting systems integrated into the structures 34A-34C, and/or the like (FIG. 8).

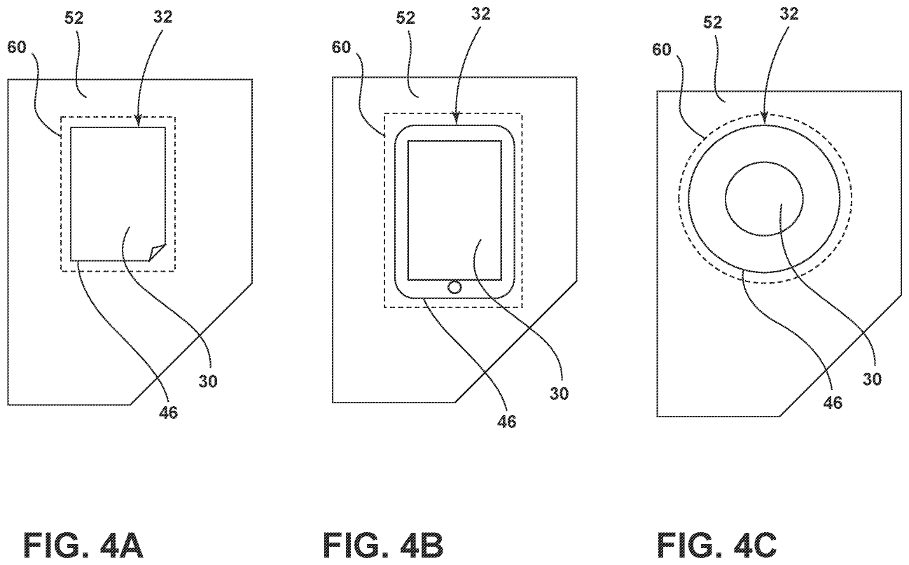

With reference now to FIGS. 4A-4C, the object 32 identified may be associated with one of a variety of categories. In response to which category the object 32 is associated with, the parameters of the light settings can be adjusted. For example, the type of light projected, the intensity, direction, and focus angle of the light projected can be modified by the control system 100 based on the categorization. It should be appreciated that the objects 32 described in reference to FIGS. 4A-4C and the type of light selected based on operational parameters are exemplary in nature and not intended to limit the selection of light settings towards any particular type or categorization of object 32.

With reference now to FIG. 4A, the object 32 may be categorized under a first category as a readable medium, such as a non-electric readable medium (e.g., a book, paper, a board game, cards, etc.). Under operational parameters of the first category, the control system 100 may be configured to identify (e.g., localize) the outer perimeter 46 of the object 32 and generate a signal to the at least one first light-emitting diode 12 to focus the first light 14 to substantially match the outer perimeter 46 of the object 32. For example, the first light 14 may be defined as a focus angle that substantially matches (e.g., within about 90% of the outer perimeter 46) or is larger than the outer perimeter 46. In this manner, nearby passengers are not greatly affected by the focused light.

With reference now to FIG. 4B, the object 32 may be categorized under a second category as an electric readable medium (e.g., a tablet or computer). Under operational parameters of the second category, the control system 100 may be configured to identify (e.g., localize) the outer perimeter 46 of the object 32 and generate a signal to the at least one first light-emitting diode 12 to focus the first light 14 to substantially match the outer perimeter 46 of the object 32. For example, the first light 14 may be defined as a focus angle that substantially matches (e.g., within about 90% of the outer perimeter 46) or is larger than the outer perimeter 46. In some embodiments, the intensity of the light under the second category is less than the first category.

With reference now to FIG. 4C, the object 32 may be categorized under a third category as a consumable (e.g., plate, cup, eating utensil, napkin, food, or drink). Under operational parameters of the third category, the control system 100 may be configured to identify (e.g., localize) the outer perimeter 46 of the object 32 and generate a signal to the at least one second light-emitting diode 16 to focus the second light 18 to substantially match the outer perimeter 46 of the object 32. For example, the second light 18 may be defined as a focus angle that substantially matches (e.g., within about 90% of the outer perimeter 46) or is larger than the outer perimeter 46.

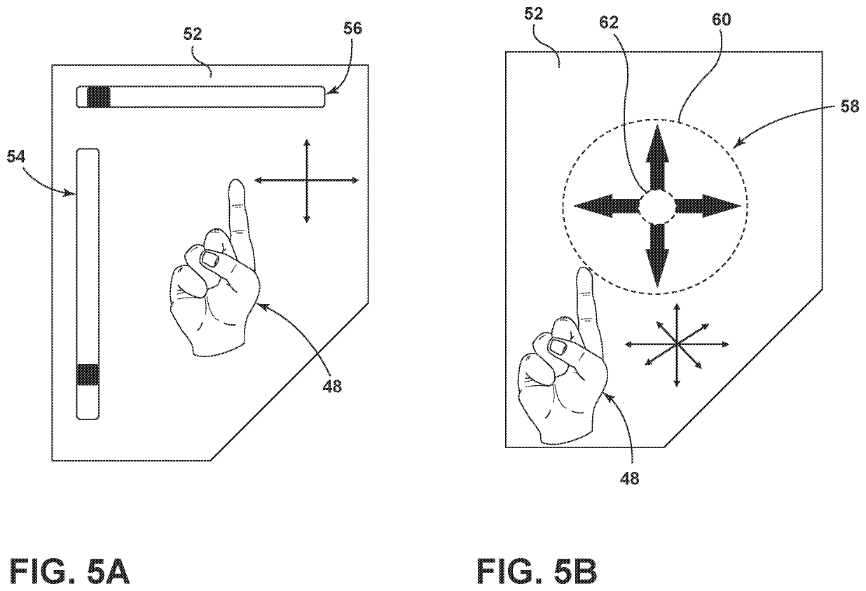

With reference now to FIGS. 5A and 5B, the control system 100 (e.g., the at least one processor 104) may further be configured to identify a hand gesture 48 in the image 28 and modify the light settings or component settings of the global command system 150. For example, the hand gesture 48 may be utilized for controlling the intensity, direction, focus angle, and type of the light 14, 18 projected. In some embodiments, the hand gesture 48 may also be utilized for adjusting the display settings, audio settings, or other lighting systems integrated into the structures 34A-34C via communication between the processor 104 and the global command system 150. In use, the control system 100 (e.g., the processor 104) is configured to identify the hand gesture 48 in a first image 28 and capture movement of the hand gesture 48 in subsequent images 28. The hand gesture 48 may be unique to the light settings or component settings of the global command system 150 or may be generic to open a digital menu 50. The digital menu 50 may be generated on the user interface 44, a display within the cabin 36, or be projected onto a particular interior surface within the cabin 36. In some embodiments, the digital menu 50 may be virtual (e.g., operable without visual guidance). For example, the interior surface within the cabin 36 may be a tabletop 52. It should be appreciated that while FIGS. 5A and 5B illustrate the digital menu 50 projected onto the tabletop 52, the same menu commands may be available for the digital menu 50 in any location. For example, the hand gesture 48 may not be necessary to obtain the digital menu 50 and movement of the hand may correspond to interfacing with a touch screen, a button, a dial, and/or the like.

With reference now to FIG. 5A, the digital menu 50 may include a first light settings control 54. With the first light settings control 54, the spectrum of the light may be selected between the first light 14 and the second light 18. In some embodiments, the first light settings control 54 may also permit adjustment of both the first light 14 and the second light 18 to obtain a spectrum substantially between the warm visible spectrum and the cool visible spectrum (i.e., by blending the first light 14 and the second light 18). For example, an intensity of the first light 14 may be reduced and an intensity of the second light 18 may be increased along (or vice versa) a sliding scale. The digital menu 50 may also include a second light settings control 56. With the second light settings control 56, an intensity of a specific one of the first light 14 and the second light 18 can be controlled on a sliding scale.

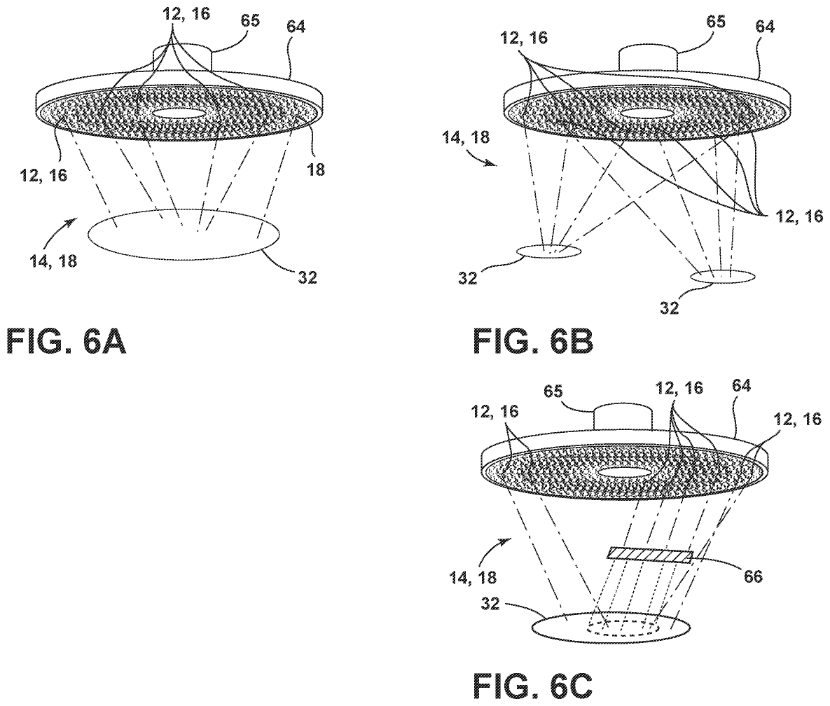

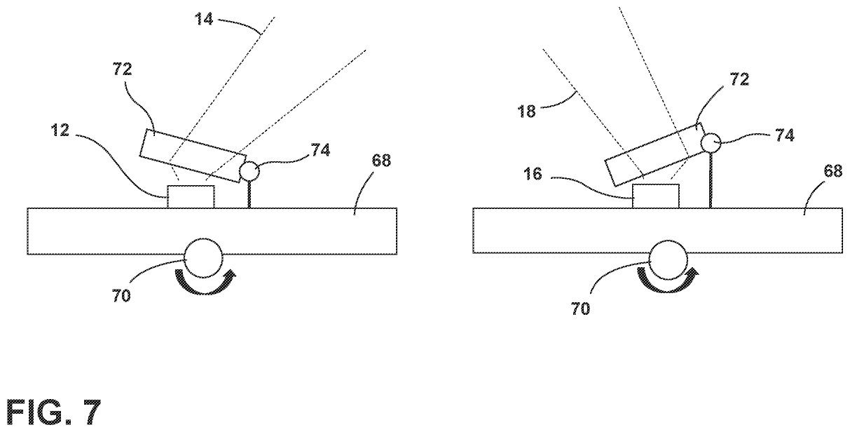

With reference now to FIG. 5B, the digital menu 50 may further include a light projection control 58. With the light projection control 58, the focus angle (e.g., the convergence or divergence angle of light projected from one or more light-emitting diodes 12) can be modified to match the outer perimeter 46 of the object 32. As will be appreciated with further reading, the term “focus angle” simply means creating an illumination that at least covers a portion of the object 32 or matches a perimeter 46 of the object 32. The focus angle can be obtained by changing the convergence or divergence angle of a single diode 12, 16 (e.g., FIG. 7) or by selectively choosing which diodes 12, 16 in an array of diodes 12, 16 that will be illuminated (e.g., FIGS. 6A-6C). For example, the light projection control 58 may include a graphic with an outer profile 60 that can be adjusted (e.g., in size and/or shape) by placing the hand gesture 48 on the outer profile 60 and moving the hand gesture 48 towards (to decrease the focus angle) or away (to increase the focus angle) a center 62 of the outer profile 60. The light projection control 58 may further allow movement of the direction of light projected. For example, by placing the hand gesture 48 into the center 62 and moving the hand gesture 48, and, consequently, moving the projected light to a different location.

FIGS. 6A and 6B illustrate the at least one first light-emitting diode 12 and the at least one second light-emitting diode 16 in a first arrangement. In the first arrangement, the at least one first light-emitting diode 12 includes a plurality of first light-emitting diodes 12 and the at least one second light-emitting diode 16 includes a plurality of second light-emitting diodes 16. Different operational modes of illumination are exemplarily illustrated, demonstrating the flexibility of the illumination system 10. The operational modes of lighting shown will be described in reference to the plurality of first light-emitting diodes 12 and the plurality of second light-emitting diodes 16. For example, the plurality of first and second light-emitting diodes 12, 16 for a given operational mode may be activated to illuminate one or more objects 32 and modify the intensity, direction, focus angle (e.g., by which diodes are activated), and type of light projected. Each of the first and second light-emitting diodes 12, 16 may be located on a substrate 64. The first and second light-emitting diodes 12, 16 may be densely arranged to provide enhanced light output and allow for control of the particular focus angle, light pattern, direction, and intensity. Lenses of various configurations may be located on different ones of the light-emitting diodes 12, 16 to control the focus angle. The substrate 64 may be parabolic-shaped. In some embodiments, the substrate 64 may be moveable via an actuating mechanism 65, such as a gear-driven arrangement and/or the like, for articulating the substrate 64 and aiming the light-emitting diodes 12, 16.

Referring now more particularly to FIG. 6A, the illumination system 10 may be configured to change directionality of light emitted from the first light-emitting diodes 12 and/or the second light-emitting diodes 16 in a first operational mode. For example, select ones of the light-emitting diodes 12, 16 (e.g., with various lenses or focus angles) may be activated via the control system 100 to illuminate the object 32 to match the outer perimeter 46 of the object 32. As illustrated, the first and second objects 32 may be aligned with opposing outer portions of the plurality of light-emitting diodes 12, 16.

Referring now to FIG. 6B, the illumination system 10 may be configured to change the directionality of light emitted from the first light-emitting diodes 12 and/or the second light-emitting diodes 16 (e.g., via the actuating mechanism 65) in a second operational mode. For example, select ones of the light-emitting diodes 12, 16 may be activated via the control system 100 to illuminate a first and second object 32 that are spaced apart. As illustrated, the first and second objects 32 may be aligned with opposing outer portions of the plurality of light-emitting diodes 12, 16.

Referring now to FIG. 6C, the illumination system 10 may be configured to change the directionality of light emitted from the first light-emitting diodes 12 and/or the second light-emitting diodes 16 (e.g., via the actuating mechanism 65) in a third operational mode. The control system 100 (e.g., the processor 104) may be configured to identify an obstruction 66 in the image 28 and select which ones of the light-emitting diodes 12, 16 are activated to circumvent the obstruction 66.

FIG. 7 illustrates the at least one first light-emitting diode 12 and the at least one second light-emitting diode 16 in a second arrangement. In the second arrangement, each single or a plurality of the light-emitting diodes 12, 16 may be located on a carrier 68. Each carrier 68 may be oriented via a carrier adjustment mechanism 70 (e.g., a gear-driven arrangement). Likewise, each single or a plurality of the light-emitting diodes 12, 16 may include a lens 72. Each lens 72 may be adjusted via a lens adjustment mechanism 74 (e.g., a gear-driven arrangement). In this manner, the orientation and focus angle of the light-emitting diodes 12, 16 may be modified with or without movement of the carrier 68.

With reference now to FIG. 8, the control system 100 of the illumination system 10 may include at least one electronic control unit (ECU) 102. The at least one ECU 102 may be located in the housing 40 or other locations around the cabin 36. The at least one ECU 102 may include the processor 104 and a memory 106. The processor 104 may include any suitable processor 104. Additionally, or alternatively, each ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid state) memory, or the like. The memory 106 may include Random Access Memory (RAM), a Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the illumination system 10. The light-emitting diodes 12, 16, the imaging assembly 20, the digital menu 50 generation, the carrier adjustment mechanism 70, and the lens adjustment mechanism 74 may, therefore, be controlled by the control system 100 and modified by the selection of the digital menu 50 and/or user interface 44. The memory 106 may, therefore, include a series of captured images 28, an object part identifying module 108, a categorization module 110, a gesture dictionary module 112, an operational parameter module 114, and a user preference module 116. The control system 100 may also be in communication with the global command system 150. In some embodiments, the control system 100 (e.g., the processor 104) may be configured to implement machine learning protocols, such as neural network algorithms to detect, localize, and categorize the object 32.

With reference now to FIGS. 1-8, the control system 100 (e.g., the processor 104) may be configured to save a selected illumination setting for the category based on a user preference (e.g., the hand gesture and/or user interface 44) and repeat the selection every time the category is identified as a user preference. For example, the user preference module 116 may be stored (e.g., temporarily during travel) as parameters selected by a user (e.g., light type and intensity) that are associated with the category. The control system 100 (e.g., the processor 104) may be configured to implement the parameters selected once the object 32 matching the category is identified for a predetermined period. For example, the predetermined period may terminate after a threshold time, arrival at a destination, and/or the like. After the predetermined period is complete, the control system 100 (e.g., the processor 104) may reset to default parameters. In some embodiments, the control system 100 (e.g., the processor 104) may determine an ambient light level in the cabin 36 (e.g., natural light or light from the lighting system in the structures 34A-34C) and adjust the intensity of the light projected from the light-emitting diodes 12, 16. For example, when the control system 100 determines that the level of ambient lighting is low, the intensity of the light projected from the light-emitting diodes 12, 16 may be reduced or increased based on the default parameters or the user-selected parameters (e.g., in the user preference module 116).

With continued reference to FIGS. 1-8, the examples are exemplary in nature, for example, each of the categories as described herein may be associated with the first light 14 only, the second light 18 only, or a blend of the first light 14 and second light 16. In this manner, the control system 100 (e.g., the processor 104) may be configured to, upon determining a category of the object 32, generate a signal to the first light-emitting diode 12 only, the second light-emitting diode 16 only, or a combination of the first and second light-emitting diodes 12, 16 to obtain a blended spectrum between the warm and cool visible spectrums.

The disclosure herein is further summarized in the following paragraphs and is further characterized by combinations of any and all of the various aspects described therein.

According to one aspect of the present disclosure, an illumination system includes at least one first light-emitting diode that is configured to project a first light within a cool visible spectrum and at least one second light-emitting diode that is configured to project a second light within a warm visible spectrum. An imaging assembly includes an infrared light source that is configured to project an infrared light and an imager that captures an image of a reflection of the infrared light from a surface of an object. A processor is configured to extract a 2-dimensional (“2D”) representation of the object from the image, identify and categorize the object, and generate an illumination signal to at least one of the at least one first light-emitting diode or the at least one second light-emitting diode based on the category of the object to illuminate the object.

According to another aspect, a processor is configured to identify an outer perimeter of an object and generate a signal to focus a first light or a second light to substantially match an outer perimeter of the object.

According to yet another aspect, a processor is configured to apply a categorization to an object identified as a readable medium and apply a different categorization to an object identified as a consumable.

According to still another aspect, a processor is configured to, upon applying a categorization to a readable medium, generate a signal to at least one first light-emitting diode only. The processor is further configured to, upon applying a different categorization to a consumable, generate a signal to at least one second light-emitting diode only.

According to another aspect, a processor is configured to identify a hand gesture in an image and modify a convergence or divergence angle of a first light or a second light based on the hand gesture.

According to yet another aspect, a processor is configured to identify a hand gesture in an image and switch between a first light and a second light based on the hand gesture.

According to still another aspect, a processor is configured to save a selected illumination setting for an object based on a hand gesture and repeat the selection every time the object is identified as a user preference.

According to another aspect, a user interface is in communication with a processor. The user interface provides an option to switch between a first light and a second light and modify a convergence or divergence angle of the first light or the second light.

According to another aspect of the present disclosure, an illumination system includes at least one first light-emitting diode that is configured to project a first light within a first visible spectrum and at least one second light-emitting diode that is configured to project a second light within a second visible spectrum that is different than the first visible spectrum.

An imaging assembly includes an infrared light source that is configured to project an infrared light and an imager that captures an image of a reflection of the infrared light from a surface of an object. A processor is configured to extract a 2-dimensional (“2D”) representation of the object from the image, identify and categorize the object, and generate an illumination signal to at least one of the at least one first light-emitting diode or the at least one second light-emitting diode based on the category of the object to illuminate the object.

According to another aspect, a first visible spectrum is between about 350 nm and about 500 nm.

According to yet another aspect, a second visible spectrum is between about 500 nm and about 700 nm.

According to still yet another aspect, a processor is configured to identify an outer perimeter of an object and generate a signal to focus a first light or a second light to substantially match an outer perimeter of the object.

According to another aspect, a processor is configured to apply a categorization to an object identified as a readable medium and apply a different categorization to an object identified as a consumable.

According to yet another aspect, a processor is configured to, upon applying a categorization to a readable medium, generate a signal to at least one first light-emitting diode only. The processor is further configured to, upon applying a different categorization to a consumable, generate a signal to at least one second light-emitting diode only.

According to still yet another aspect, a processor is configured to identify a hand gesture in an image and modify a convergence or divergence angle of a first light or a second light based on the hand gesture.

According to another aspect, a hand gesture in an image and switch between a first light and a second light based on the hand gesture.

According to yet another aspect of the present disclosure, an illumination system includes at least one first light-emitting diode that is configured to project a first light within a first visible spectrum and at least one second light-emitting diode that is configured to project a second light within a second visible spectrum that is different than the first visible spectrum.

An imaging assembly includes an infrared light source that is configured to project an infrared light and an imager that captures an image of a reflection of the infrared light from a surface of an object. A processor is configured to extract a 2-dimensional (“2D”) representation of the object from the image, identify and categorize the object, identify a perimeter of the object, and generate an illumination signal to at least one of the at least one first light-emitting diode or the at least one second light-emitting diode based on the category of the object to illuminate at least the perimeter of the object.

According to another aspect, a first visible spectrum is between about 350 nm and about 500 nm.

According to yet another aspect, a second visible spectrum is between about 500 nm and about 700 nm.

According to still yet another aspect, a processor is configured to apply a categorization to an object identified as a readable medium and apply a different categorization to an object identified as a consumable.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed:

1. An illumination system comprising:
at least one first light-emitting diode configured to project a first light within a cool visible spectrum;
at least one second light-emitting diode configured to project a second light within a warm visible spectrum;
an imaging assembly comprising:
an infrared light source configured to project an infrared light; and
an imager that captures an image of a reflection of the infrared light from a surface of an object;
a processor configured to:
extract a 2-dimensional (“2D”) representation of the surface from the image;
identify and categorize the object; and
generate an illumination signal to at least one of the at least one first light-emitting diode and the at least one second light-emitting diode based on a category of the object to illuminate the object.

2. The illumination system of claim 1, wherein the processor is further configured to:
identify an outer perimeter of the object; and
generate the illumination signal to focus the first light or the second light to substantially match the outer perimeter of the object.

3. The illumination system of claim 1, wherein the processor is further configured to:
apply a categorization to the object identified as a readable medium; or
apply a different categorization to the object identified as a consumable.

4. The illumination system of claim 3, wherein the processor is further configured to:
upon applying the categorization to the readable medium, generate the illumination signal to the at least one first light-emitting diode only; and
upon applying the different categorization to the consumable, generate the illumination signal to the at least one second light-emitting diode only.

5. The illumination system of claim 1, wherein the processor is further configured to:
identify a hand gesture in the image; and
modify a convergence or divergence angle of the first light or the second light based on the hand gesture.

6. The illumination system of claim 5, wherein the processor is further configured to:
identify the hand gesture in the image; and
switch between the first light and the second light based on the hand gesture.

7. The illumination system of claim 6, wherein the processor is further configured to:
save a selected illumination setting for the object based on the hand gesture; and
repeat the selected illumination setting every time the object is identified as a user preference.

8. The illumination system of claim 1, further comprising a user interface in communication with the processor, the user interface providing an option to switch between the first light and the second light and modify a convergence or divergence angle of the first light or the second light.

9. An illumination system comprising:
at least one first light-emitting diode configured to project a first light within a first visible spectrum;
at least one second light-emitting diode configured to project a second light within a second visible spectrum that is different than the first visible spectrum;
an imaging assembly comprising:
an infrared light source configured to project an infrared light; and
an imager that captures an image of a reflection of the infrared light from a surface of an object;
a processor configured to:
extract a 2-dimensional (“2D”) representation of the surface from the image;
identify and categorize the object; and
generate an illumination signal to at least one of the at least one first light-emitting diode and the at least one second light-emitting diode based on a category of the object to illuminate the object.

10. The illumination system of claim 9, wherein the first visible spectrum is between about 350 nm and about 500 nm.

11. The illumination system of claim 10, wherein the second visible spectrum is between about 500 nm and about 700 nm.

12. The illumination system of claim 9, wherein the processor is further configured to:
identify an outer perimeter of the object; and
generate the illumination signal to focus the first light or the second light to substantially match the outer perimeter of the object.

13. The illumination system of claim 9, wherein the processor is further configured to:
apply a categorization to the object identified as a readable medium; or
apply a different categorization to the object identified as a consumable.

14. The illumination system of claim 13, wherein the processor is further configured to:
upon applying the categorization to the readable medium, generate the illumination signal to the at least one first light-emitting diode only; and
upon applying the different categorization to the consumable, generate the illumination signal to the at least one second light-emitting diode only.

15. The illumination system of claim 9, wherein the processor is further configured to:
identify a hand gesture in the image; and
modify a convergence or divergence angle of the first light or the second light based on the hand gesture.

16. The illumination system of claim 15, wherein the processor is further configured to:
identify the hand gesture in the image; and
switch between the first light and the second light based on the hand gesture.

17. An illumination system comprising:
at least one first light-emitting diode configured to project a first light within a first visible spectrum;
at least one second light-emitting diode configured to project a second light within a second visible spectrum that is different than the first visible spectrum;
an imaging assembly comprising:
an infrared light source configured to project an infrared light; and
an imager that captures an image of a reflection of the infrared light from a surface of an object;
a processor configured to:
extract a 2-dimensional (“2D”) representation of the surface from the image;
identify and categorize the object;
identify a perimeter of the object; and
generate an illumination signal to at least one of the at least one first light-emitting diode and the at least one second light-emitting diode based on a category of the object to illuminate at least the perimeter of the object.

18. The illumination system of claim 17, wherein the first visible spectrum is between about 350 nm and about 500 nm.

19. The illumination system of claim 18, wherein the second visible spectrum is between about 500 nm and about 700 nm.

20. The illumination system of claim 19, wherein the processor is further configured to:
apply a categorization to the object identified as a readable medium; or
apply a different categorization to the object identified as a consumable.
